(19) United States
(12) Patent Application Publication
(10) Pub. No.: US 2008/0221724 A1
(43) Pub. Date: Sep. 11, 2008

(54) Method For Positioning Reel-To-Reel Flexible Board In Automatic Manufacturing Process

(76) Inventors: Chih-Fu Chung, Taoyuan Hsien (TW); Chiu-Tang Chen, Hsinchu Hsien (TW)

Correspondence Address: LIN & ASSOCIATES INTELLECTUAL PROPERTY, INC., P.O. BOX 2339, SARATOGA, CA, 95070-0339, US

(21) Appl. No.: 11/684,586

(22) Filed: Mar. 9, 2007

(51) Int. Cl. G06F 19/00

(52) U.S. Cl. 700/114; 700/95

(57) ABSTRACT

A method for positioning a reel-to-reel flexible board in an automatic manufacturing process uses an optical sensor to detect a first edge and a second edge of the reel-to-reel flexible board and obtain first x-coordinate data, second x-coordinate data and y-coordinate data. A set of positioning holes is precisely formed using the obtained coordinate data. The positioning holes are used to define a starting point of a next work area to prevent the gap between the two work areas from being larger or smaller than a predetermined value. Because micro-via forming and image transfer procedures are applied on the reel-to-reel flexible board using the coordination data, shift and offset can be prevented.

### BACKGROUND OF THE INVENTION

1. Field of the Invention

The present invention relates to a method for positioning a flexible board, and in particular to a method for positioning a reel-to-reel flexible board in an automatic manufacturing process.

2. The Prior Arts

The flexible printed circuit board is manufactured by an automatic manufacturing process called a reel-to-reel or roll-to-roll process. A flexible board is moved from a supply reel to a take-up reel in a predetermined step interval. A machine installs a plurality of electronic components onto preset circuit on the flexible board. Wire bonding and molding is then performed. After the resin is dried, the roll of the flexible board is then cut to the predetermined product. The leftovers are then cleared up.

In the manufacturing process mentioned above, perforation holes provided at both sides of the flexible board are used as a positioning reference. However, because the conveying devices for the flexible board have inherent mechanical errors, the problems, such as misalignment or shifting, are likely to occur. Besides, because the flexible board is very thin, the punching positions of the perforation holes are likely to fall outside the allowable tolerances. Thus, the positioning precision is hard to control.

As current trend of the electronic products tends to be lighter and thinner, the precision requirement of the flexible board is also raised. Therefore, it will not meet the precision requirement in the future if it only depends the perforation holes as reference for positioning.

In order to solve the problems, Taiwan Patent No. 1228024, “Method for Manufacturing Reel-to-Reel Flexible Circuit Board”, is proposed to overcome the disadvantage that the perforation holes are incapable of providing highly precision positioning.

Referring to FIG. 1A, a set of positioning holes 10a-10d are formed at both sides of a flexible board 10 for each predetermined section. Then, based on relative distances between the positioning holes 10a and 10d, and 10b and 10c, an optical sensor (such as a CCD) and a computer with preset reference data are provided to locate positions and adjust the positioning. Thereafter, an image transfer procedure is applied on the flexible board 10 to form a plurality of patterned circuits. The image transfer procedure includes steps of exposure, development, etching, and removing photoresistance, etc.

Referring to FIG. 1B, in an automatic manufacturing process, a section of the reel-to-reel flexible board 10 is divided into a plurality of work areas 12a-12c. Each work area 12a-12c is corresponding to a job region of a machine, and contains a plurality of patterned circuits. Then the image transfers are applied onto the work areas 12a-12c in batch. However, a conveyor, a punching machine, etc are used to form the positioning holes 10a-10d. That is the positioning holes 10a-10d are mechanically positioned. Thus, the mechanical errors are reduced but still exist. Therefore, the problems, such as shifting and the gap larger or smaller than a preset value (as shown in FIG. 1B), still remain.

### SUMMARY OF THE INVENTION

A primary objective of the present invention is to provide a method for positioning a reel-to-reel flexible board in an automatic manufacturing process, which utilizes an optical sensor to detect both edges of the reel-to-reel flexible board and obtain x-coordinate data, and y-coordinate data. Because the positioning holes used as reference of positioning are not located by mechanically means, the shifts and offsets can be prevented in the image transfer procedure.

Another objective of the present invention is to provide a method for positioning a reel-to-reel flexible board in an automatic manufacturing process, which utilizes the measured coordinate data to precisely locate and form the positioning holes. The positioning holes are then precisely defines a starting point of a next work area. Therefore, it prevents the gap between two work areas from being larger or smaller than the preset value.

In order to achieve the objectives, the method for positioning a reel-to-reel flexible board in an automatic manufacturing process in accordance with the present invention detects a first edge of the reel-to-reel flexible board, scans across the reel-to-reel flexible board, and detects a second edge of the reel-to-reel flexible board. X-coordinate data and y-coordinate data obtained from the detecting are then used to perform precise positioning.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is a schematic view showing a conventional reel-to-reel flexible board having positioning holes at both edges;

FIG. 1B is a schematic view showing a section of the conventional reel-to-reel flexible board being divided into a plurality of work areas and having a shift and a gap larger or smaller than a preset value; and

FIGS. 2A-2G are schematic views showing a sequence of events of a method for positioning a reel-to-reel flexible board in an automatic manufacturing process in accordance with the present invention.

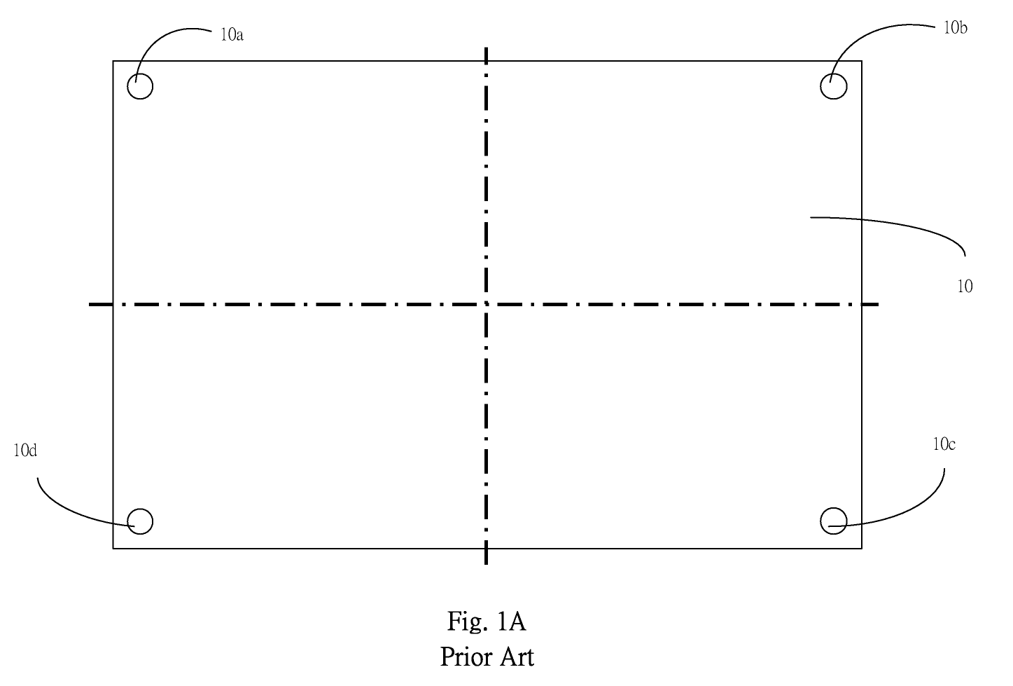

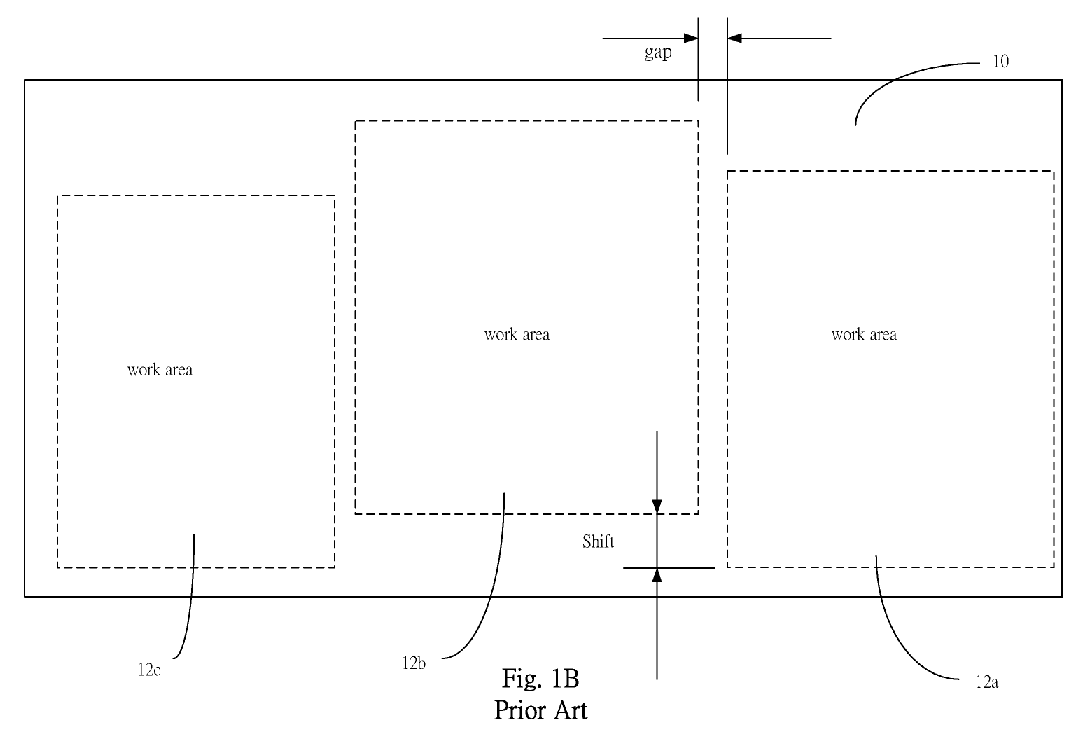

### DETAILED DESCRIPTION OF THE PREFERRED EMBODIMENT

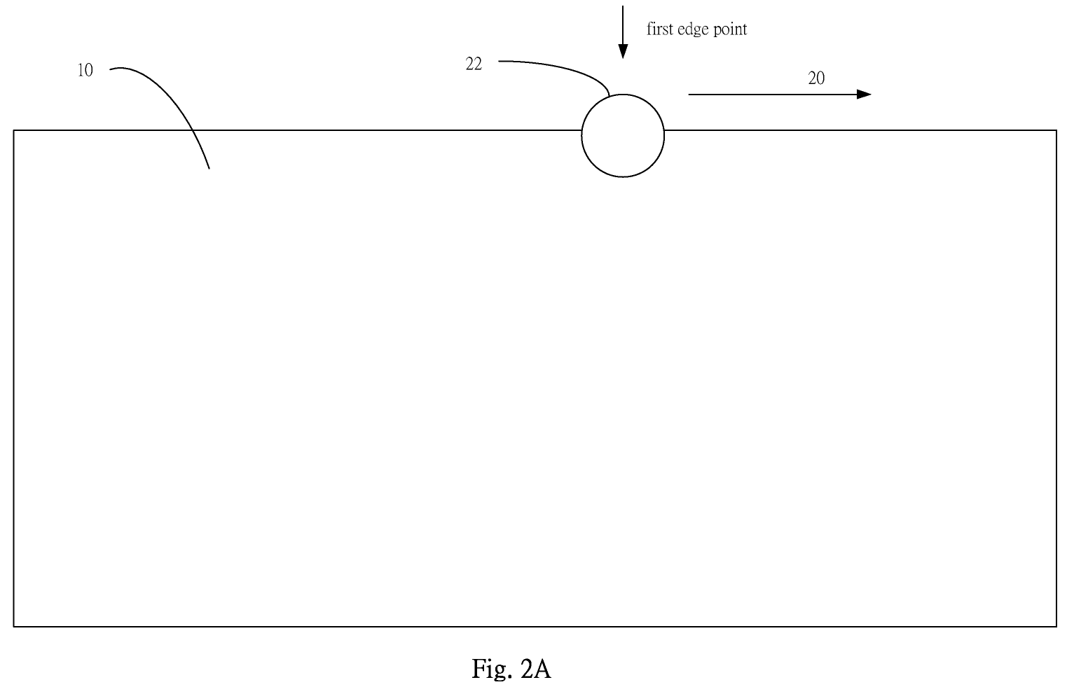

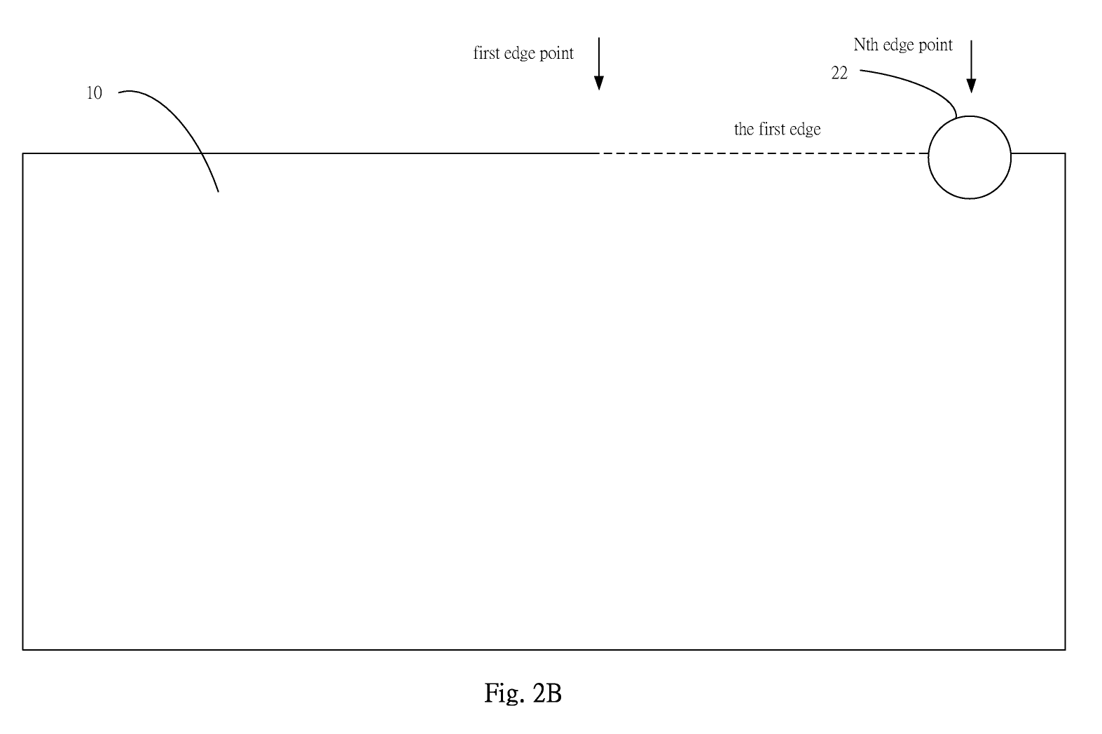

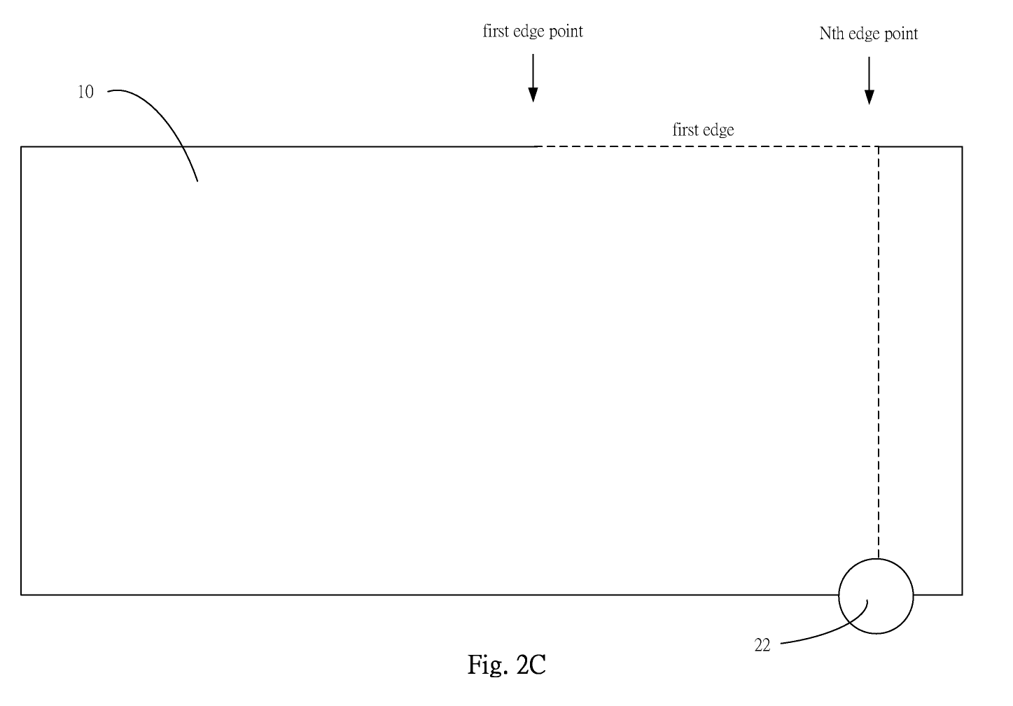

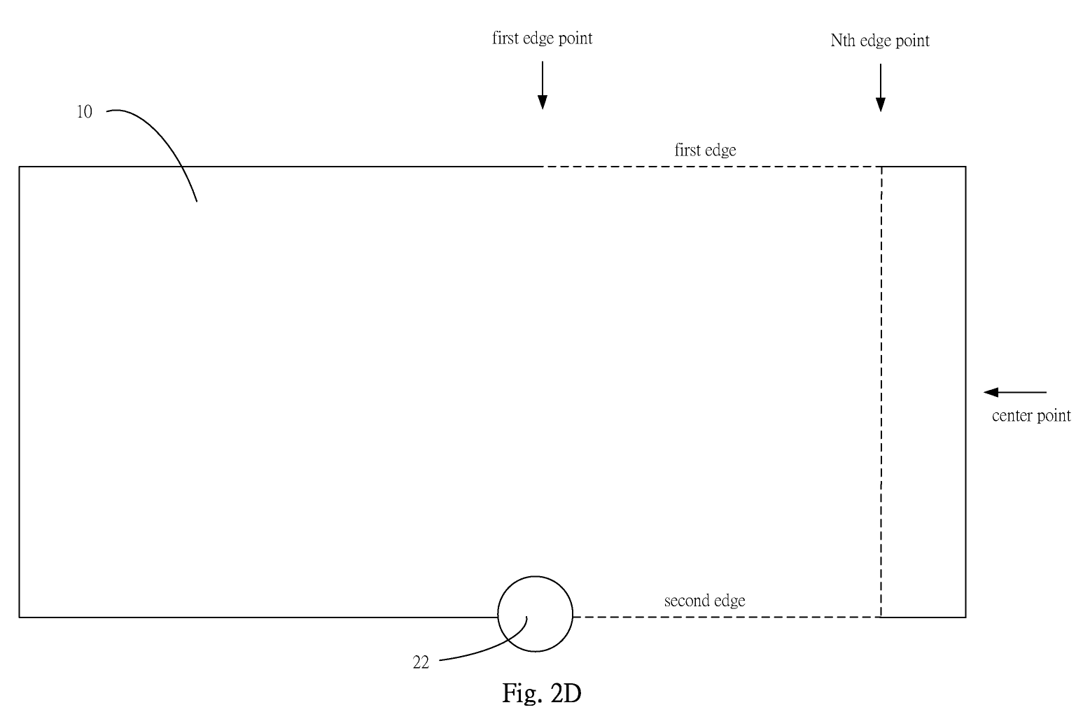

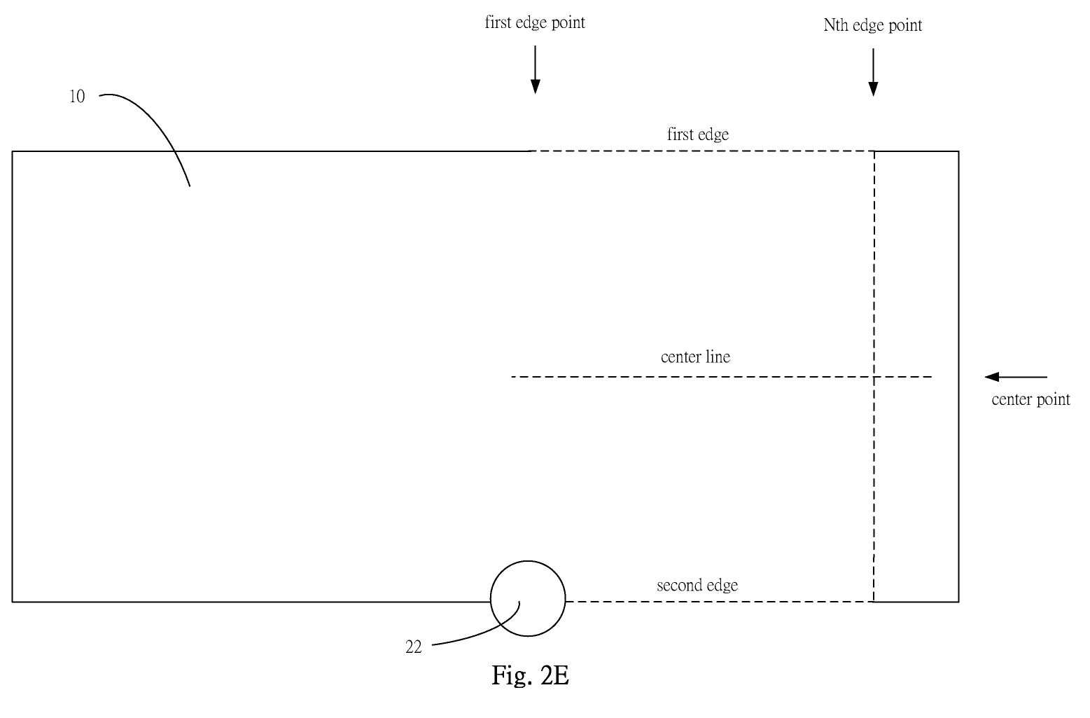

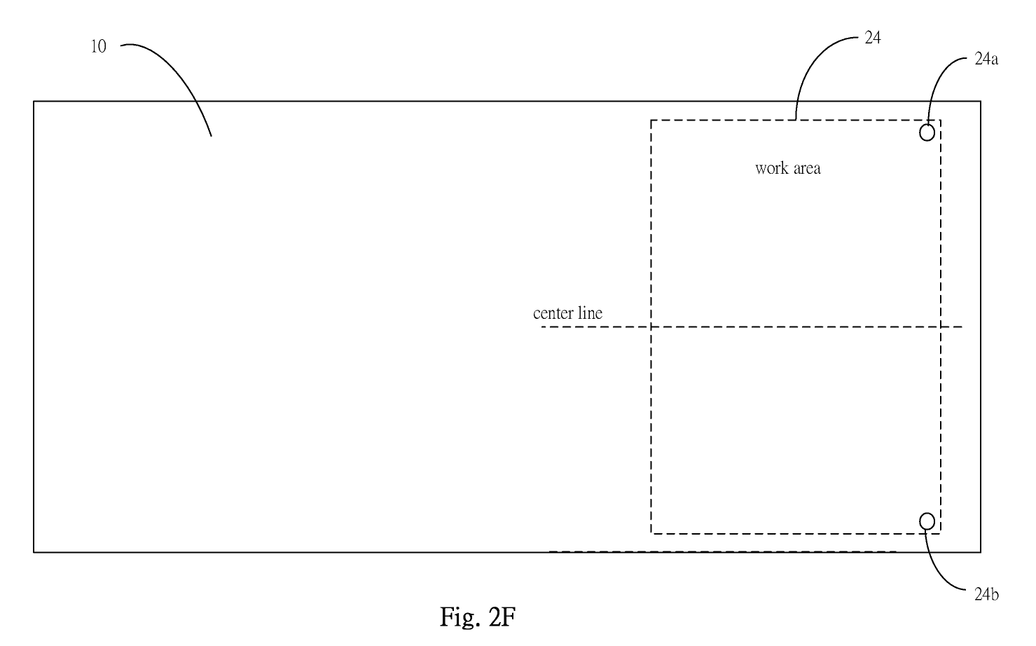

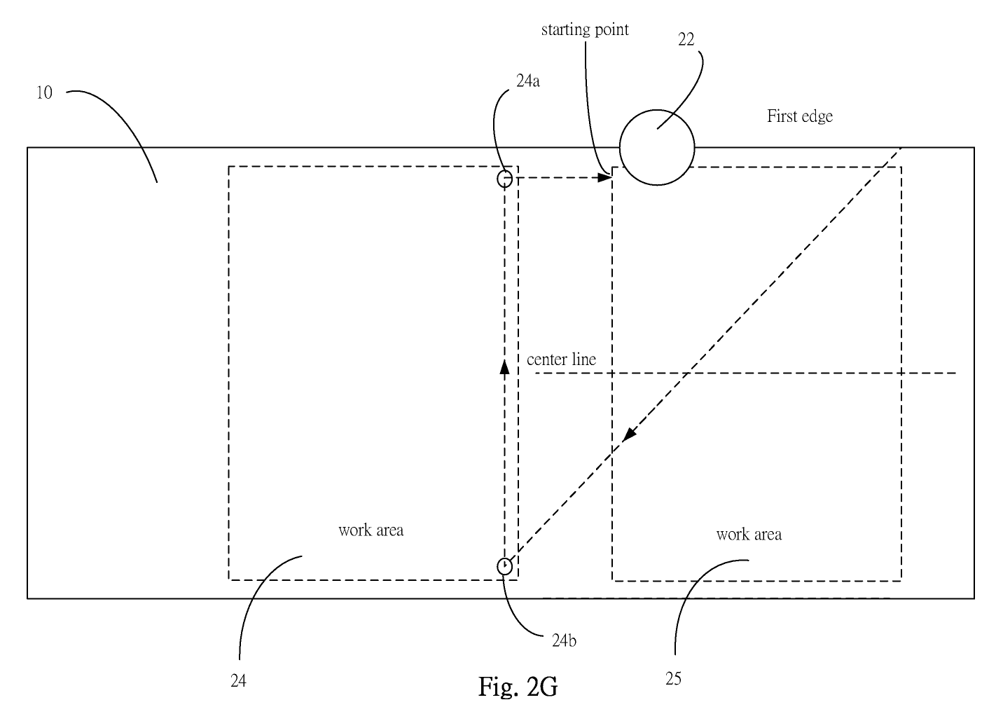

FIGS. 2A-2G show a method for positioning a reel-to-reel flexible board in an automatic manufacturing process in accordance with the present invention. Referring to FIGS. 2A-2E, first x-coordinate data, second x-coordinate data and y-coordinate data are obtained by detecting a first edge and a second edge of the reel-to-reel flexible board 10. Referring to FIG. 2F, the coordinate data are used to define a work area 24, and a micro-via forming procedure is applied on the reel-to-reel flexible board 10. Because the positioning process is not a mechanical positioning process, the shift and offset can be prevented during the procedure. Thereafter, the coordinate data are used to precisely form positioning holes 24a and 24b. Referring to FIG. 2G, the positioning holes 24a and 24b are then used to precisely define the next work area 25, thereby preventing the gap between the work areas 24 and 25 from being larger or smaller than the predetermined value.

As shown in FIG. 2D, an optical sensor 22 locates an edge of a reel-to-reel flexible board 10 by means of detecting the presence of the reel-to-reel flexible board 10.

Referring to FIGS. 2A-2B, using the method mentioned above, the optical sensor 22 locates a first edge point at an edge of the reel-to-reel flexible board 10. The optical sensor 22 then moves in an arrow direction 20, and locates a second edge point, a third edge point, . . . until an Nth edge point. The edge points define a first edge, and provide first x-coordinate data. A second edge is defined in the same manner as the first edge. If these edge points are not on a straight line, they could be optimized to a straight line.

Referring to FIG. 2C, after the first edge is defined, the optical sensor 22 moves across the reel-to-reel flexible board 10 and toward the opposing edge (until the absence of the reel-to-reel flexible board 10 is detected). Thus, y-coordinate data are obtained. Then the optical sensor 22 defines the second edge and obtains second x-coordinate data of the reel-to-reel flexible board 10, just as the optical sensor 22 defines the first edge. After the two x-coordinate data are obtained, the x-coordinate data and the y-coordinate data are calibrated based on the principle that the two edges should be parallel to each other.

Referring to FIGS. 2D and 2E, using the coordinate data, a center point and a centerline parallel to the first edge and the second edge are defined. Referring to FIG. 2F, a work area 24 is precisely defined according to the coordinate data, and a micro-via forming process is performed precisely on the reel-to-reel flexible board 10. Before or after completing the manufacturing process on the work area 24, the coordinate data is used to precisely form a set of positioning holes 24a and 24b without any mechanical errors.

After the positioning holes 24a and 24b of the work area 24 are formed, a next work area 25 can be defined. The positioning holes 24a and 24b are used to determine a starting point of the work area 25.

Referring to FIG. 2G, the optical sensor 22 locates a first edge of the work area 25, and moves diagonally from the first edge to the positioning hole 24b and then to the positioning hole 24a of the work area 24, thereby precisely locating the starting point of the next work area 25.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for positioning a reel-to-reel flexible board in an automatic manufacturing process, comprising:
detecting a first edge of the reel-to-reel flexible board to obtain a set of first x-coordinate data;
detecting from the first edge across the reel-to-reel flexible board to a second edge of the reel-to-reel flexible board to obtain a set of y-coordinate data; and
detecting the second edge of the reel-to-reel flexible board to obtain a set of second x-coordinate data.

2. The method as claimed in claim 1, wherein an optical sensor detects the first edge and the second edge of the reel-to-reel flexible board by means of sensing presence of the reel-to-reel flexible board.

3. The method as claimed in claim 2, wherein the optical sensor detects a plurality of edge points of the reel-to-reel flexible board, and the edge points define the first edge and the second edge.

4. The method as claimed in claim 1, wherein the reel-to-reel flexible board is divided into a plurality of work areas corresponding to a job region of a machine so that an image transfer procedure is applied on the reel-to-reel flexible board in batches.

5. The method as claimed in claim 1, wherein a set of positioning holes is formed on the reel-to-reel flexible board using the first x-coordinate data, the y-coordinate data and the second x-coordinate data as reference.

6. The method as claimed in claim 5, wherein a starting point of a next work area is determined using the set of positioning holes as reference.
